(19) United States
(12) Patent Application Publication
(10) Pub. No.: US 2016/0066005 A1
(43) Pub. Date: Mar. 3, 2016

(54) METHODS AND APPARATUS TO IDENTIFY REMOTE PRESENTATION OF STREAMING MEDIA

(71) Applicant: The Nielsen Company (US), LLC, Schaumburg, IL (US)

(72) Inventors: Jeremey M. Davis, New Port Richey, FL (US); Derrick McCulley, Tampa, FL (US); Arun Ramaswamy, Tampa, FL (US)

(21) Appl. No.: 14/473,455

(22) Filed: Aug. 29, 2014

(51) Int. Cl. H04N 21/258; H04L 29/08; H04N 21/442; H04N 21/24; H04N 21/44; H04N 21/234; H04L 12/26; H04N 21/25

(52) U.S. Cl. CPC H04N 21/25808; H04L 43/04; H04L 67/10; H04L 67/02; H04N 21/251; H04N 21/24; H04N 21/44008; H04N 21/23418; H04N 21/44231

(57) ABSTRACT

Methods and apparatus to identify remote presentation of streaming media are disclosed. An example method includes determining a first identification of streaming data transmitted to a streaming media device. A second identification of media presented by a media presentation device is determined. The first identification is compared to the second identification to determine whether first media identified by the first identification matches second media identified by the second identification. In response to determining that the first media matches the second media, a panelist associated with at least one of the streaming media device and the media presentation device is credited as having been presented the first media by the media presentation device on behalf of the streaming media device.

### FIELD OF THE DISCLOSURE

This disclosure relates generally to media monitoring, and, more particularly, to methods and apparatus to identify remote presentation of streaming media.

### BACKGROUND

Internet access to media has become widespread. Media is now frequently streamed to consumers via streaming services such as, Netflix™, Hulu™, and others. Streaming enables media to be delivered to and presented by a wide variety of media devices, such as a digital versatile disc (DVD) player, a smart TV, an Apple TV®, a Roku™ media player, a Boxee™ media player, a Sony PlayStation™, a Microsoft® Xbox®, an Apple iPad®, etc. A significant portion of media (e.g., content and/or advertisements) is presented via streaming to such devices.

### BRIEF DESCRIPTION OF THE DRAWINGS

FIG. 1 is a block diagram of an example system constructed in accordance with the teachings of this disclosure for identifying remote playback of streaming media.

FIG. 2 is a block diagram of an example configuration of the system shown in FIG. 1, illustrating an example flow of media among the network devices of FIG. 1.

FIGS. 3, 4, and 5 are block diagram(s) of example configuration(s) of the example network devices shown in FIG. 1.

FIG. 6 is a block diagram of the example media monitor of FIG. 1.

FIG. 7 is a block diagram of the example central facility of FIG. 1.

FIG. 8 is a flowchart representative of example machine-readable instructions that may be executed to implement the media monitor of FIGS. 1 and/or 6.

FIG. 9 is an example data table representing example data collected by the example media monitor of FIG. 1.

FIG. 10 is a flowchart representative of example machine-readable instructions that may be executed to implement the media monitor of FIGS. 1 and/or 6.

FIG. 11 is a flowchart representative of example machine-readable instructions that may be executed to implement the example central facility of FIGS. 1 and/or 7.

FIG. 12 is a flowchart representative of example machine-readable instructions that may be executed to implement the example central facility of FIGS. 1 and/or 7.

FIG. 13 is a block diagram of an example processor platform capable of executing the example machine-readable instructions of FIGS. 8, 10, 11, and/or 12 to implement the example media monitor of FIGS. 1 and/or 6, and/or the example central facility of FIGS. 1 and/or 7.

The figures are not to scale. Wherever possible, the same reference numbers will be used throughout the drawing(s) and accompanying written description to refer to the same or like parts.

### DETAILED DESCRIPTION

The use of media devices (e.g., a DVD player, an Apple TV®, a Roku™ media player, a Boxee™ media player, a Sony PlayStation™, a Microsoft® Xbox®, an Apple iPad®, etc.) to present streaming media available via the Internet has increased in recent years. As used herein “media” refers to audio and/or visual (still or moving) content and/or advertisements. As used herein, streaming and/or streaming media refers to media that is presented to a user by a media device at least partially in parallel with the media being transmitted (e.g., via a network) to the media device (or a device associated with the media device) from a media provider.

As different types of media providers and media applications (e.g., a Netflix™ application, a Hulu™ application, a Pandora™ application, etc.) for such media devices have been created, the popularity of streaming media has increased. Indeed, some households have eliminated traditional sources of media (e.g., satellite television, cable television) in favor of such streaming devices. In view of the increasing popularity of accessing media in this manner, understanding how users interact with the streaming media (e.g., such as by understanding what media is presented, how the media is presented, who is accessing such media, etc.) provides valuable information to service providers, advertisers, content providers, media providers, manufacturers, and/or other entities.

In some examples, users view streaming media via a streaming device such as, for example, a smartphone, a tablet, a personal computer, etc. Streaming media is transmitted from a media provider (e.g., a streaming media provider such as, for example, Netflix™, Hulu™, etc.) to the streaming device via a network. In some examples, the media is displayed by the streaming device that receives the streaming media. However, in some examples, the streaming device uses remote presentation techniques to present the media via a media presentation device such as, for example, a television.

In some examples, the remote presentation is implemented by transmitting the media to the media presentation device (e.g., the television) via, for example, a home network, an audio/video cable (e.g., a High Definition Media Interface (HDMI) cable, a Digital Video Interface (DVI) cable, etc.). In some other examples, in lieu of transmitting the media to the media presentation device, the streaming device may transmit an identifier (e.g., a Universal Resource Locator (URL)) of the streaming media such that the media presentation device can request the streaming media for presentation. In some examples, such remote presentation techniques are sometimes referred to as casting, screencasting, slinging, etc.

Example methods, apparatus, systems, and articles of manufacture disclosed herein may be used to identify remote presentation of streaming media. Some such example methods, apparatus, and/or articles of manufacture measure such exposure based on media metadata, user demographics, and/or media device types. Some examples disclosed herein may be used to monitor streaming media transmissions received at media devices adapted to receive streaming media such as a DVD player, a Smart TV, an Apple TV®, a Roku™ media player, a Boxee™ media player, a Sony PlayStation™, a Microsoft® Xbox®, an Apple iPad®, and/or any other device capable of playing media.

Example monitoring processes disclosed herein collect media monitoring information from media presentation devices and streaming devices to identify media presentations that occur with facilitation from a streaming device. In some media presentation examples, media is retrieved using one device, but presented using another device. For example, media may be retrieved via an Apple iPad®, but presented by a television. Different streaming devices and/or streaming services may have different user interfaces and, as a result, may result in different levels of use for one streaming device for a particular streaming service among users having different demographics. For example, males between the ages of forty and fifty may prefer streaming using an Apple iPad®, whereas males between the ages of twenty and thirty may prefer streaming using a Google Chromecast™. Streaming device developers and streaming service providers have an interest in understanding these preferences of their consumers.

Audio watermarking is a technique used to identify media such as television broadcasts, radio broadcasts, advertisements (television and/or radio), downloaded media, streaming media, prepackaged media, etc. Existing audio watermarking techniques identify media by embedding audio codes (e.g., a watermark), such as media identifying information and/or an identifier that may be mapped to media identifying information, into an audio and/or video component having a signal characteristic sufficient to hide the watermark. In some examples, video watermark techniques may additionally or alternatively be used. For example, a video watermark may be applied to a chroma of a video for later extraction and/or identification.

As used herein, the terms “code” and “watermark” are used interchangeably and are defined to mean any identification information (e.g., an identifier) that may be inserted or embedded in the audio and/or video of media (e.g., a program or advertisement) for the purpose of identifying the media or for another purpose such as tuning (e.g., a packet identifying header). To identify watermarked media, the watermark(s) are extracted and compared to reference watermarks that are mapped to media identifying information.

Unlike media monitoring techniques based on codes and/or watermarks included with and/or embedded in the monitored media, fingerprint, or signature-based, media monitoring techniques generally use one or more inherent characteristics of the monitored media during a monitoring time interval to generate a substantially unique proxy for the media. Such a proxy is referred to as a signature or fingerprint, and can take any form (e.g., a series of digital values, a waveform, etc.) representative of any aspect(s) of the media signal(s)(e.g., the audio and/or video signals forming the media presentation being monitored). A good signature is one that is repeatable when processing the same media presentation, but that is unique relative to other (e.g., different) presentations of other (e.g., different) media. Accordingly, the term “fingerprint” and “signature” are used interchangeably herein and are defined herein to mean a proxy for identifying media that is generated from one or more inherent characteristics of the media.

Signature-based media monitoring generally involves determining (e.g., generating and/or collecting) signature(s) representative of a media signal (e.g., an audio signal and/or a video signal) output by a monitored media device and comparing the monitored signature(s) to one or more references signatures corresponding to known (e.g., reference) media sources. Various comparison criteria, such as a cross-correlation value, a Hamming distance, etc., can be evaluated to determine whether a monitored signature matches a particular reference signature. When a match between the monitored signature and one of the reference signatures is found, the monitored media can be identified as corresponding to the particular reference media represented by the reference signature that matched the monitored signature. Because attributes, such as an identifier of the media, a presentation time, a broadcast channel, etc., are collected for the reference signature, these attributes may then be associated with the monitored media whose monitored signature matched the reference signature.

In some examples, media that is presented via a media device does not have an embedded code and/or watermark. Furthermore, a signature and/or fingerprint may not be known for the media. As such, in some examples, the presented media might not be identifiable via traditional identification techniques. For example, user-generated YouTube videos may not be identifiable using traditional identification techniques. As such, other identification techniques, such as monitoring Ethernet packets may be used to enable identification of the media.

In some disclosed examples, a media presentation device includes a network interface to transmit a request for media to be presented by the media presentation device. In such examples, the media presentation device requests media from a media provider via a network (e.g., the Internet). In some examples, the request for media is a HyperText Transfer Protocol (HTTP) request, an HTTP Secure (HTTPS) request, a Session Initiation Protocol (SIP) message, a domain name service (DNS) query, a file transfer protocol (FTP) request, and/or any other type of request for media. Based on the request, a media monitor may be able to identify presented media. For example, if a user requests a YouTube video that is not identifiable using traditional audio identification techniques, a universal resource locator (URL) of the request may be used to identify the media.

In some examples, a media monitor is used to capture network communications of all devices on the network. The media monitor is installed at a media exposure measurement location (e.g., a household) and identifies network communications to and/or from network devices within the media exposure measurement location. Thus, the media monitor monitors all network devices within the media exposure measurement location. The media monitor creates a log and/or a record of the network communications and transmits the log and/or the record to the network activity measurement system. In some examples, the log of network communications created by the media monitor may be transmitted by physically mailing the log.

Some example methods, apparatus, and articles of manufacture disclosed herein are located at a media exposure measurement location having one or more media presentation devices. Some of these example methods, apparatus, and articles of manufacture are interposed between the media presentation devices and a wide area network (WAN), such as the Internet, that includes one or more media providers that provide media in response to request(s) from the media presentation devices. Some example methods, apparatus, and articles of manufacture disclosed herein intercept messages to and/or from the WAN (e.g., media requests from media presentation devices on the same LAN as the media monitor).

As disclosed herein, some example methods, apparatus, and articles of manufacture disclosed herein inspect the network communications to facilitate identification of media. For example, when the example media monitor identifies that a media presentation device is presenting media, but that media is not identifiable using traditional audio identification techniques, the media monitor may inspect network communications to determine an identity of the media. Moreover, by utilizing both traditional audio identification techniques and network-based identification techniques, the example media monitor can identify when media is being streamed to a first device (e.g., an iPad), but is displayed via another device.

As noted above, streaming media to a first device, but remotely presenting the media via a second device is sometimes referred to as “slinging” or “casting.” Different implementations of slinging/casting may be used. For example, the first media device may transmit an identifier of the media to be presented via the second device, such that the second device may request the media for presentation. In some examples, the first media device requests the media and, upon receipt, forwards the media to the second device.

In examples disclosed herein, the streaming device can be identified based on the monitored network communications. For example, when a streaming device (e.g., an iPad) transmits a request to an Internet media provider, the media monitor monitors the request to identify the requested media and, in some examples, the streaming device. In some examples, the media is identified based on a portion of a URL of the request. In some examples, the streaming device is identified based on an Internet Protocol (IP) address of the streaming device. In some examples, other techniques for identifying the streaming device such as, for example, inspecting a user agent portion of a header of the request, performing an Address Resolution Protocol (ARP) lookup to resolve a hardware identifier of the streaming device may be used, etc. Resolving a hardware identifier enables identification of the streaming device. In some examples, the media monitor inspects the request to identify a streaming media provider to which the request was transmitted.

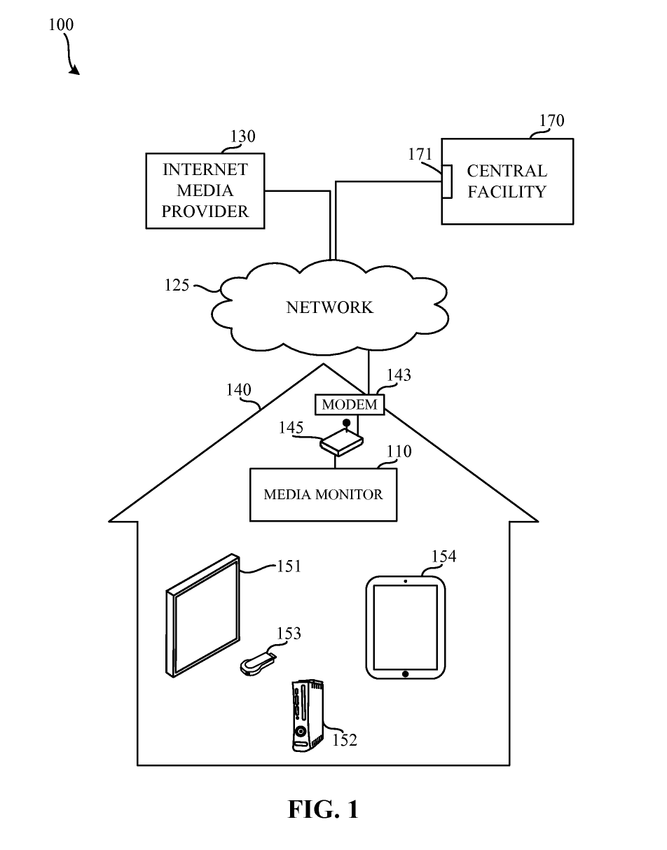

FIG. 1 is a block diagram of an example system 100 constructed in accordance with the teachings of this disclosure to identify remote presentation of streaming media. The example system of FIG. 1 includes a media monitor 110 to monitor media presented by media devices 151, 152, 153, 154. Further shown are an example network 125, an example Internet media provider 130, an example media exposure measurement location 140, an example modem 143, an example network gateway 145, and an example central facility 170.

The network 125 of the illustrated example of FIG. 1 is a wide area network (WAN) such as the Internet. However, in some examples, local networks may additionally or alternatively be used. For example, multiple networks may be utilized to couple the components of the example system 100 to identify media presentation devices.

The Internet media provider 130 of the illustrated example of FIG. 1 is a server providing Internet media (e.g., web pages, audio, videos, images, etc.). The Internet media provider 130 may be implemented by any provider(s) of media such as a digital broadcast provider (cable television service, fiber-optic television service, etc.) and/or an on-demand digital media provider (e.g., Internet streaming video and/or audio services such as Netflix®, YouTube®, Hulu®, Pandora®, Last.fm®) and/or any other provider of streaming media services. In some other examples, the Internet media provider 130 is a host for web site(s). Additionally or alternatively, the Internet media provider(s) 130 may not be on the Internet. For example, the media provider may be on a private and/or semi-private network (e.g., a LAN, a virtual private network) to which the media device(s) 151, 152, 153, 154 connect.

The media exposure measurement location 140 of the illustrated example of FIG. 1 is a panelist household. However, the media exposure measurement location 140 may be any other location, such as, for example an Internet café, an office, an airport, a library, a non-panelist household, etc. While in the illustrated example a single media exposure measurement location 140 is shown, any number and/or type(s) of media exposure measurement locations may be used.

The modem 143 of the illustrated example of FIG. 1 is a modem that enables network communications of the media exposure measurement location 140 to reach the network 125. In some examples, the modem 143 is a digital subscriber line (DSL) modem, while in some other examples the modem 143 is a cable modem. In some examples, the modem 143 is a media converter that converts one communications medium (e.g., electrical communications, optical communications, wireless communications, etc.) into another type of communications medium. In the illustrated example, the modem 143 is separate from the network gateway 145. However, in some examples, the modem 143 may be a part of (e.g., integral to) the network gateway 145.

The example network gateway 145 of the illustrated example of FIG. 1 is a router that enables the media devices 151, 152, 153, 154 to communicate with the network 125 (e.g., the Internet.) In some examples, the example network gateway 145 includes gateway functionality such as modem capabilities. In some other examples, the example network gateway 145 is implemented in two or more devices (e.g., a router, a modem, a switch, a firewall, etc.).

In some examples, the example network gateway 145 hosts a LAN for the media exposure measurement location 140. In the illustrated example, the LAN is a wireless local area network (WLAN), and allows the media devices 151, 152, 153, 154 to transmit and receive data via the Internet. Alternatively, the network gateway 145 may be coupled to such a LAN.

The example central facility 170 of the illustrated example is a server that collects and processes media monitoring information from the media monitor 110 to generate exposure metrics related to presented media. The central facility 170 analyzes the media monitoring information to identify, for example, which media presentation devices are the most owned, the most-frequently used, the least-frequently owned, the least-frequently used, the most/least-frequently used for particular type(s) and/or genre(s) of media, and/or any other media statistics or aggregate information that may be determined from the data. The media presentation device information may also be correlated or processed with factors such as geodemographic data (e.g., a geographic location of the media exposure measurement location, age(s) of the panelist(s) associated with the media exposure measurement location, an income level of a panelist, etc.) Media presentation device information may be useful to manufacturers and/or advertisers to determine which features should be improved, determine which features are popular among users, identify geodemographic trends with respect to media presentation devices, identify market opportunities, and/or otherwise evaluate their own and/or their competitors' products.

In the illustrated example, the central facility 170 includes an Internet interface 171 to receive Internet messages (e.g., a HyperText Transfer Protocol (HTTP) request(s)) that include the metering information. Additionally or alternatively, any other method(s) to receive metering information may be used such as, for example, an HTTP Secure protocol (HTTPS), a file transfer protocol (FTP), a secure file transfer protocol (SFTP), etc.

In the illustrated example, the media exposure measurement location 140 includes media devices 151, 152, 153, 154. In the illustrated example of FIG. 1, some of the media device(s) are streaming media device(s) 152, 153, 154, while some of the media devices are media presentation device(s) 151. In some examples, the media presentation device(s) 151 also functions as a streaming media device.

The media devices 151, 152, 153, 154 of FIG. 1 are devices that retrieve media from the Internet media providers 130 for presentation at the media exposure measurement location 140. In some examples, the media devices 151, 152, 153, 154 are capable of directly presenting media (e.g., via a display) while, in some other examples, the media devices present the media on separate media presentation equipment (e.g., speakers, a display, etc.). For example, the media presentation device 151 of the illustrated example is an Internet enabled television, and thus, is capable of presenting media (e.g., via an integrated display and speakers). The media device 152 of the illustrated example is a gaming console (e.g., Xbox®, Playstation® 3, etc.) and requires additional media presentation equipment (e.g., a television) to present media. The media device 153 of the illustrated example is a streaming media device (e.g., a Google Chromecast, an Apple TV) that requires additional media presentation equipment to present media. The example media device 154 of the illustrated example is another streaming media device (e.g., an iPad, a tablet, etc.) that does not require additional media presentation equipment to present streaming media. While in the illustrated example, the example media device 154 does not require additional media presentation equipment, the example media device 154 may transmit media for presentation to a separate media device (e.g., the television).

While, in the illustrated example, an Internet enabled television, a gaming console, and two streaming devices are shown, any other type(s) and/or number(s) of media presentation device(s) may additionally or alternatively be used. For example, Internet-enabled mobile handsets (e.g., a smartphone), digital media players (e.g., a Roku® media player, a Slingbox®, etc.,) etc. may additionally or alternatively be used. Further, while in the illustrated example four media devices are shown, any number of media presentation devices may be used.

The media monitor 110 of the illustrated example of FIG. 1 is a network device that communicates on the LAN hosted by the example network gateway 145. Additionally or alternatively, the example media monitor may be interposed between the LAN hosted by the example network gateway 145 and the network 125. The media monitor 110 of the illustrated example identifies network communications from the media devices 151, 152, 153, 154. The media monitor 110 also performs media identification of media presented by the media devices 151, 152, 153, 154 by using media monitoring techniques such as, for example, detection and/or identification of audio codes and/or signatures. The network communications monitor 110 creates a record (e.g., a log) identifying which of the media presentation device(s) 151, 152, 153, 154 were involved in which of the network communications and transmits the record to the central facility 170. In some examples, the media monitor 110 determines which device was involved in the network communications by inspecting the network communications passing through the media monitor 110 to identify, for example, an Internet Protocol (IP) address of the device, a serial number of the device, a make and/or a model of the device, etc.

In some examples, the example network gateway 145 permits custom firmware and/or software to be loaded and/or executed. In some such examples, the network gateway 145 may be provided with firmware and/or software that, in addition to standard routing and/or modem behavior, monitors messages or data packets directed from the media devices 151, 152, 153, 154 to the network 125 and/or directed from the network 125 to the media devices 151, 152, 153, 154. Additionally or alternatively, such monitoring functionality may be part of a separate device such as, for example, the media monitor 110.

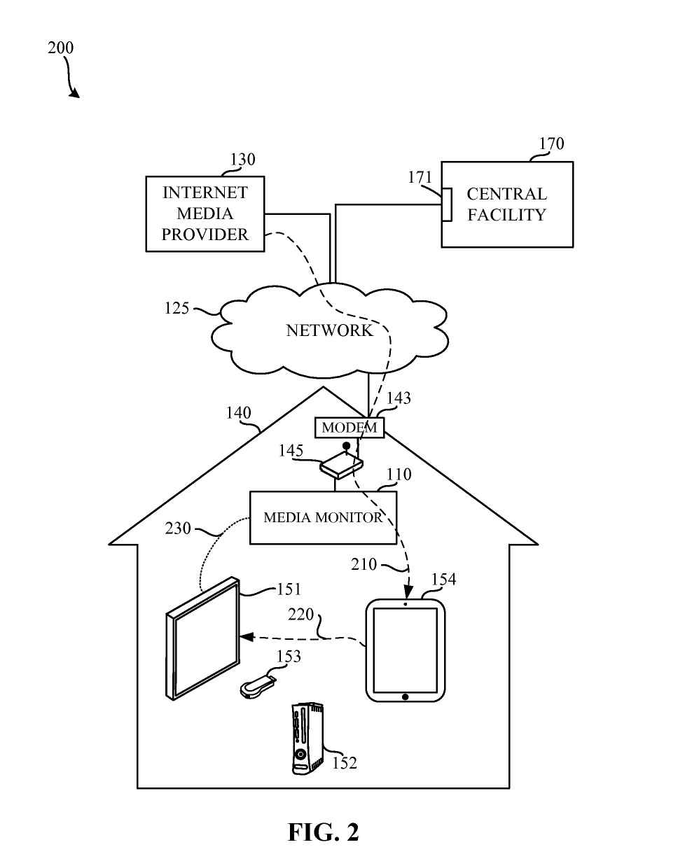

FIG. 2 is a block diagram of an example configuration of the system shown in FIG. 1, illustrating an example flow of media among the media devices of FIG. 1. In the illustrated example of FIG. 2, the example flow of media begins at the Internet media provider 130. In response to a request for media from a streaming device (e.g., the streaming device 154), the example Internet media provider 130 transmits media to the streaming device (line 210). In the illustrated example, the streaming media is transmitted via the example network 125, the example modem 143, the example network gateway 145, and the example media monitor 110. Because the example flow of media passes through the example media monitor 110, the example media monitor 110 may monitor the network communications (e.g., Ethernet packets) associated with the example flow of media. In the illustrated example, upon receiving the example media flow, the streaming device 154 forwards the media to a presentation device (e.g., the Internet enabled television 151) for presentation (line 220). While the media presentation device 151 presents the media, the media monitor 110 monitors the presented media (e.g., using audio codes and/or signatures) (line 230). As such, the media monitor 110 can identify that streaming media was requested and/or received by a first media device, but presented via a second media device different from the first media device. Understanding such media flow and/or presentation facilitates an understanding of why particular devices were used over another. For example, while the Internet enabled television 151 may have been able to present the streaming media (i.e., without interaction with the streaming device 154), the user utilized the streaming device 154. Reasons for such use may be, for example, a better user experience provided by the streaming device 154, a lack of knowledge of how to operate streaming media services using the Internet enabled television 151, access to particular streaming media using one streaming media service provider over another, etc.

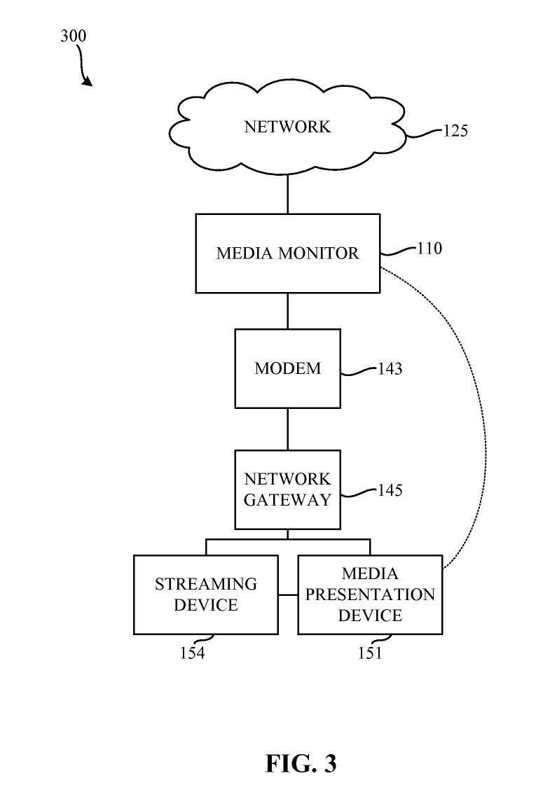

FIG. 3 is a block diagram of an example configuration 300 of the network devices shown in FIG. 1. In the example configuration 300 of the illustrated example, the media monitor 110 is placed between the network 125 and the modem 143. The modem 143 communicates with the network gateway 145, which in turn communicates with the media devices 151, 154.

In the illustrated example, the media monitor 110 monitors communications between the modem 143 and the network 125. For example, when the modem 143 is a Digital Subscriber Line (DSL) modem the media monitor 110 monitors the DSL communications. In the illustrated example, the media monitor 110 includes one or more ports (e.g., a DSL port, a cable port, etc.) for receiving and/or transmitting network communications.

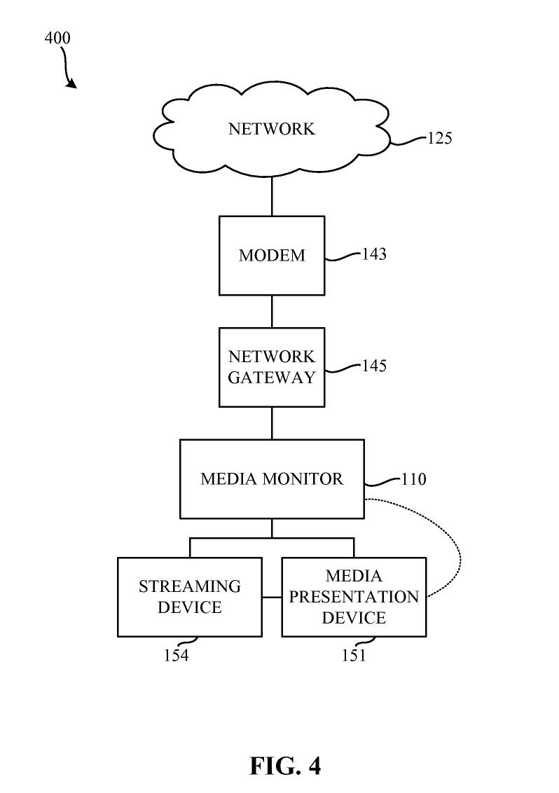

FIG. 4 is a block diagram of another example configuration 400 of the network devices shown in FIG. 1. In the example configuration 400 of FIG. 4, the media monitor 110 is intermediate the network gateway 145 and the media devices 151, 154. Thus, the modem 143 communicates with the network gateway 145. The network gateway 145 communicates with the media presentation devices 151, 154, and those communications pass through the media monitor 110.

In the illustrated example of FIG. 4, the media monitor 110 monitors communications between the network gateway 145 and the media devices 151, 154. In some examples, the media monitor 110 is a network routing device (e.g., a router, a switch, a hub, etc.) that monitors network communications. In the illustrated example, because the modem 143 and the network gateway 145 are adjacent, they may be combined into a single device. For example, a combined gateway and modem device may additionally or alternatively be used.

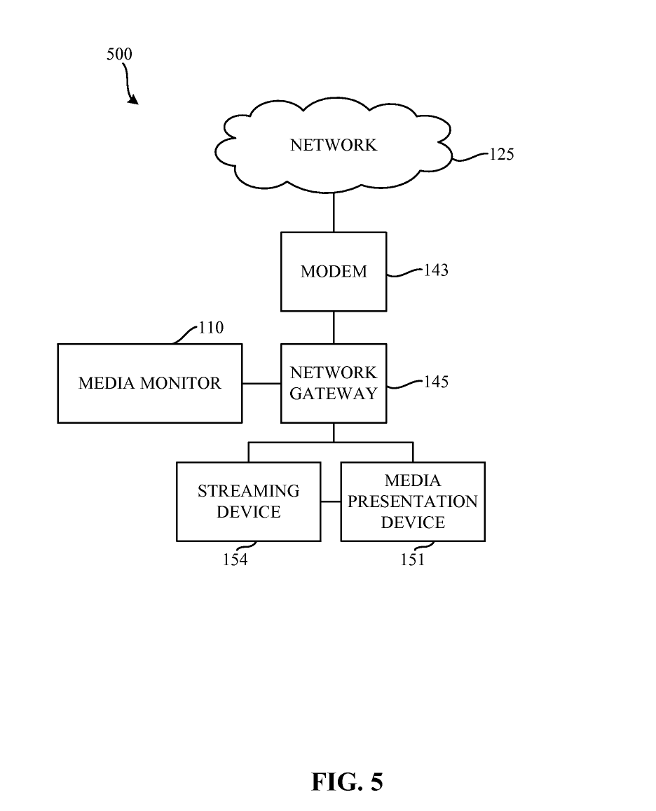

FIG. 5 is a block diagram of another example configuration 500 of the network devices shown in FIG. 1. In the example configuration 500 of FIG. 5, the media monitor 110 is adjacent the network gateway 145. In the illustrated example of FIG. 5, the example media monitor 110 does not participate in delivery of the streaming media to the streaming device 154 and/or the media presentation device 151. Rather, the media monitor 110 functions as a device on a network provided by the network gateway 145 in the same fashion as the media devices 151, 154. In the illustrated example, the modem 143 communicates with the network gateway 145, and the network gateway 145 communicates with the media devices 151, 154. The media monitor 110 interacts with the network gateway 145 to receive and/or monitor network communications of the network gateway 145. In some examples, the network gateway 145 is configured to relay communications of the media device(s) 151, 152, 153, 154 to the media monitor 110. Such communication relay may be implemented by, for example, a universal serial bus (USB) connection between the media monitor 110 and the network gateway 145, an Ethernet connection between the media monitor 110 and the network gateway 145, etc.

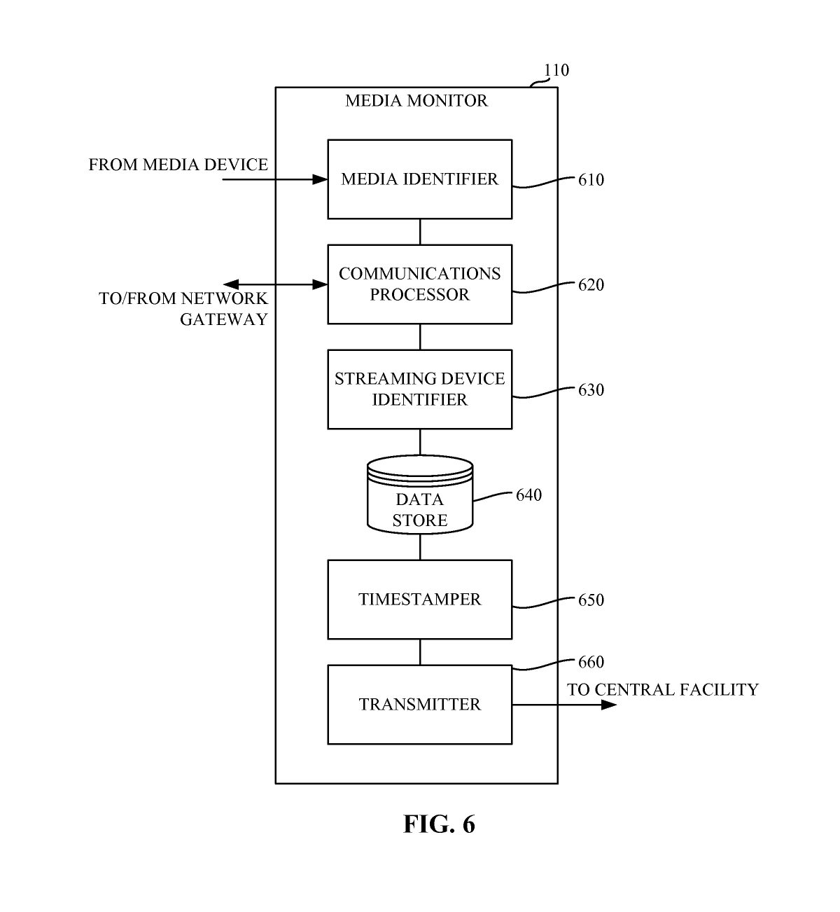

FIG. 6 is a block diagram of an example media monitor 110 to implement the media monitor 110 of FIG. 1. The example media monitor 110 of FIG. 6 includes a media identifier 610, a communications processor 620, a streaming device identifier 630, a data store 640, a timestamper 650, and a transmitter 660.

The example media identifier 610 of the illustrated example of FIG. 6 is implemented by a processor executing instructions, but it could alternatively be implemented by an Application Specific Integrated Circuit (ASIC), Digital Signal Processor (DSP), Field Programmable Gate Array (FPLD), or other circuitry. In the illustrated example, the media identifier 610 identifies media presented by a media device. In the illustrated example, the media identifier 610 uses codes and/or signatures to identify the presented media. However, any other technique for identifying media may additionally or alternatively be used.

In the illustrated example, the media identifier 610 receives audio and/or video from a media device. As such, the media identifier 610 may identify the device that presented the media in addition to identifying the media itself. However, in some other examples, the media identifier 610 may receive ambient audio and, as a result, may not be able to specifically identify which media device presented the media. In some examples, the media identifier 610 may use other techniques to identify which device presented the media such as, for example, on/off detection, etc.

The communications processor 620 of the illustrated example of FIG. 6 is implemented by a processor executing instructions, but it could alternatively be implemented by an Application Specific Integrated Circuit (ASIC), Digital Signal Processor (DSP), Field Programmable Gate Array (FPLD), or other circuitry. In the illustrated example, the communications processor 620 receives network communications (e.g., HTTP requests, etc.) from the network gateway 145, the media devices 151, 152, 153, 154, and/or the modem 143. In some examples, the communications processor 620 functions as a proxy that transmits the network communications to the network 125, and receives and/or transmits network communications in the reverse path (e.g., towards the LAN). In the illustrated example, the communications processor 620 hosts an Ethernet interface. However, any other type of interface may additionally or alternatively be used. For example, the communications processor 620 might include one or more of a Bluetooth interface, a WiFi interface, a digital subscriber line (DSL) interface, a T1 interface, etc. While in the illustrated example a single communications processor 620 is shown, any number and/or type(s) of network communicators may additionally or alternatively be used. For example, two communications processors may be used. In some examples, the communications processor is implemented in a housing separate from the media monitor such as, for example, an Ethernet Pass Through device (e.g., an Ethernet hub, an Ethernet switch, etc.).

The streaming device identifier 630 of the illustrated example of FIG. 6 inspects network communications received by the communications processor 620 to identify a media device associated with the communications. The example streaming device identifier 630 of FIG. 6 is implemented by a processor executing instructions, but it could alternatively be implemented by an Application Specific Integrated Circuit (ASIC), Digital Signal Processor (DSP), Field Programmable Logic Device (FPLD (e.g., a Field Programmable Gate Array (FPGA)), or other circuitry. In the illustrated example, streaming device identifier 630 monitors addresses of devices on the network to identify the streaming device. In some examples, the streaming device identifier 630 queries the network gateway 145 to resolve a hardware address of a streaming device on the local area network. The hardware address such as, for example, a media access control (MAC) address, a serial number, etc. enables identification of a make and/or model of the streaming device. In some examples, the streaming device identifier may query the streaming device itself to determine the make, model, version, etc. of the streaming device.

The data store 640 of the illustrated example of FIG. 6 may be any device for storing data such as, for example, flash memory, magnetic media, optical media, etc. Furthermore, the data stored in the data store 640 may be in any data format such as, for example, binary data, comma delimited data, tab delimited data, structured query language (SQL) structures, etc. While, in the illustrated example, the data store 640 is illustrated as a single database, the data store 640 may be implemented by any number and/or type(s) of databases.

The example timestamper 650 of the illustrated example of FIG. 6 records a time at which a media event occurred (e.g., a detection of media by the media identifier 610, a detection of media by the communications processor 620, etc.). Timestamping enables the central facility 170 to accurately determine when the identified media was presented.

The transmitter 660 of the illustrated example of FIG. 6 transmits network communications data stored in the data store 640. In the illustrated example, the transmitter 660 is implemented by a processor executing instructions, but it could alternatively be implemented by an ASIC, DSP, FPLD, or other circuitry. The transmitter 660 of the illustrated example periodically and/or a-periodically transmits data from the data store 640 to the central facility 170.

The example transmitter 660 may transmit the network communications data upon determining that the amount of data stored in the data store 640 has reached a threshold, and/or in response to a timer reaching a threshold (e.g., a time limit specifying that network communications are transmitted once every day). Transmitting data every day ensures that there is little lag time between the occurrence of the media presentation and the ability to analyze the same. However, the transmission may occur at any desired interval(s) such as, for example, transmitting once every hour, once every week, etc. In examples in which the transmission is triggered based on an amount of data stored in the data store 640, the transmission threshold might indicate that data should be transmitted if there is more than a predetermined amount (e.g., one megabyte) of data stored in the network communications data store 640. Any data storage amount may be used for such a trigger such as, for example, ten megabytes, one hundred megabytes, etc. Additionally or alternatively, multiple transmission thresholds may be present. For example, a threshold indicating that data should be transmitted at least once a day and a threshold indicating that network communications data should be transmitted if more than one megabyte of network communications data is stored in the data store 640 might be used.

In the illustrated example, the transmitter 660 transmits the data via the network 125. However, the transmitter 660 may transmit data via any other communication medium. For example, the media monitor 110 may be physically mailed to the central facility 170 and the transmitter 660 might transmit data via, for example, a USB connection, a Bluetooth connection, a serial connection, a local area network (LAN), etc.

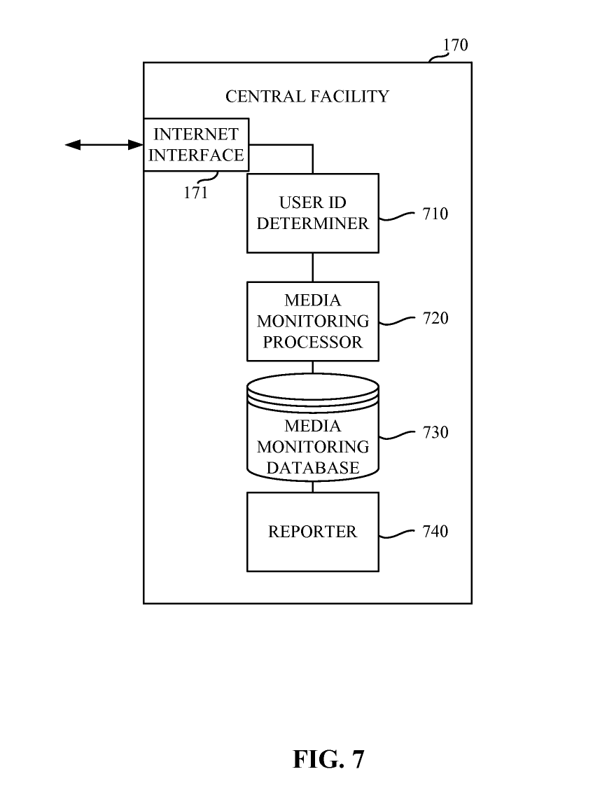

FIG. 7 is a block diagram of an example implementation of the example central facility 170 of FIG. 1. The central facility 170 of the illustrated example of FIG. 7 includes the example Internet interface 171, an example user ID determiner 710, an example media monitoring processor 720, an example media monitoring database 730, and an example reporter 740.

The example Internet interface 171 of the illustrated example of FIG. 7 is implemented by a logic circuit such as a processor executing instructions, but it could additionally or alternatively be implemented by an analog circuit, an ASIC, DSP, FPLD, and/or other circuitry. In the illustrated example, the example Internet interface 171 implements a web server that receives monitoring information from the example media monitor 110. In the illustrated example, the monitoring information is formatted as an HTTP message. However, any other message format and/or protocol may additionally or alternatively be used such as, for example, a file transfer protocol (FTP), a simple message transfer protocol (SMTP), an HTTP secure (HTTPS) protocol, etc.

The example user ID determiner 710 of the illustrated example of FIG. 7 is implemented by a logic circuit such as a processor executing instructions, but it could additionally or alternatively be implemented by an analog circuit, an ASIC, DSP, FPLD, and/or other circuitry. In the illustrated example, the example user ID determiner 710 identifies a user ID based on information received from the media monitor 110. In the illustrated example the user ID determiner 710 identifies a user and/or plurality of users (e.g., a household) associated with the media monitor 110 from which the media monitoring information was received. Based on the identified user and/or plurality of users, the example user ID determiner 710 enables demographic information to be associated with the media monitoring information. The demographic information associated with a plurality of users (e.g., a household of panelists) may be more generic (e.g., the family associated with the media device lives in Bloomingdale, Ill.) than demographic information associated with a particular user (the user of the media device lives in Bloomingdale, Ill., is a Caucasian male, and is interested in board games).

The example media monitoring processor 720 of the illustrated example of FIG. 7 is implemented by a logic circuit such as a processor executing instructions, but it could additionally or alternatively be implemented by an analog circuit, an ASIC, DSP, FPLD, and/or other circuitry. In the illustrated example, the media monitoring processor 720 processes the received media monitoring information to measure exposure to streaming media. In some examples, the media monitoring processor 720 performs comparisons of received media monitoring information to determine whether a streaming device was involved in a media presentation (e.g., was media streamed from an iPad to a television.)

The example media monitoring database 730 of the illustrated example of FIG. 7 may be implemented by any device for storing data such as, for example, flash memory, magnetic media, optical media, etc. Furthermore, the data stored in the media monitoring database 730 may be in any data format such as, for example, binary data, comma delimited data, tab delimited data, structured query language (SQL) structures, etc. In the illustrated example, the example media monitoring database 730 stores metadata (e.g., codes, signatures, etc.) used to identify media. In some examples, the media monitoring database 730 additionally stores user identifying information and/or demographics such that received user identifiers can be translated into demographic information.

The example reporter 740 of the illustrated example of FIG. 7 is implemented by a logic circuit such as a processor executing instructions, but it could additionally or alternatively be implemented by an analog circuit, an ASIC, DSP, FPLD, and/or other circuitry. In the illustrated example, the example reporter 740 prepares media measurement reports indicative of the exposure and/or demographics identified via the received monitoring information.

While an example manner of implementing the example media monitor 110 of FIG. 1 is illustrated in FIG. 6, and an example manner of implementing the example central facility 170 of FIG. 1 is illustrated in FIG. 7, one or more of the elements, processes and/or devices illustrated in FIGS. 6 and/or 7 may be combined, divided, re-arranged, omitted, eliminated and/or implemented in any other way. Further, the example media identifier 610, the example communications processor 620, the example streaming device identifier 630, the example data store 640, the example timestamper 650, the example transmitter 660, and/or more generally, the example media monitor 110 of FIGS. 1 and/or 6, and/or the example Internet interface 171, the example user ID determiner 710, the example media monitoring processor 720, the example media monitoring database 730, the example reporter 740, and/or more generally, the example central facility 170 of FIGS. 1 and/or 7 may be implemented by hardware, software, firmware and/or any combination of hardware, software and/or firmware. Thus, for example, any of the example media identifier 610, the example communications processor 620, the example streaming device identifier 630, the example data store 640, the example timestamper 650, the example transmitter 660, and/or more generally, the example media monitor 110 of FIGS. 1 and/or 6, and/or the example Internet interface 171, the example user ID determiner 710, the example media monitoring processor 720, the example media monitoring database 730, the example reporter 740, and/or more generally, the example central facility 170 of FIGS. 1 and/or 7 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example media identifier 610, the example communications processor 620, the example streaming device identifier 630, the example data store 640, the example timestamper 650, the example transmitter 660, the example Internet interface 171, the example user ID determiner 710, the example media monitoring processor 720, the example media monitoring database 730, and/or the example reporter 740 is/are hereby expressly defined to include a tangible computer readable storage device or storage disk such as a memory, a digital versatile disk (DVD), a compact disk (CD), a Blu-ray disk, etc. storing the software and/or firmware. Further still, the example media monitor 110 of FIGS. 1 and/or 6, and/or the example central facility 170 of FIGS. 1 and/or 7 may include one or more elements, processes and/or devices in addition to, or instead of, those illustrated in FIGS. 6 and/or 7, and/or may include more than one of any or all of the illustrated elements, processes and devices.

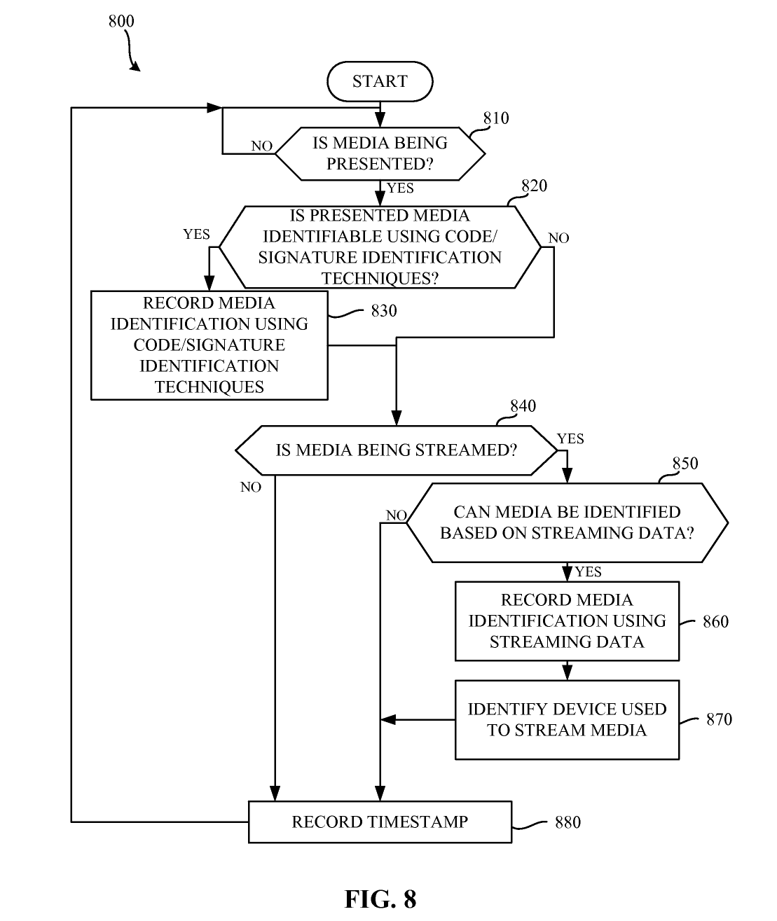

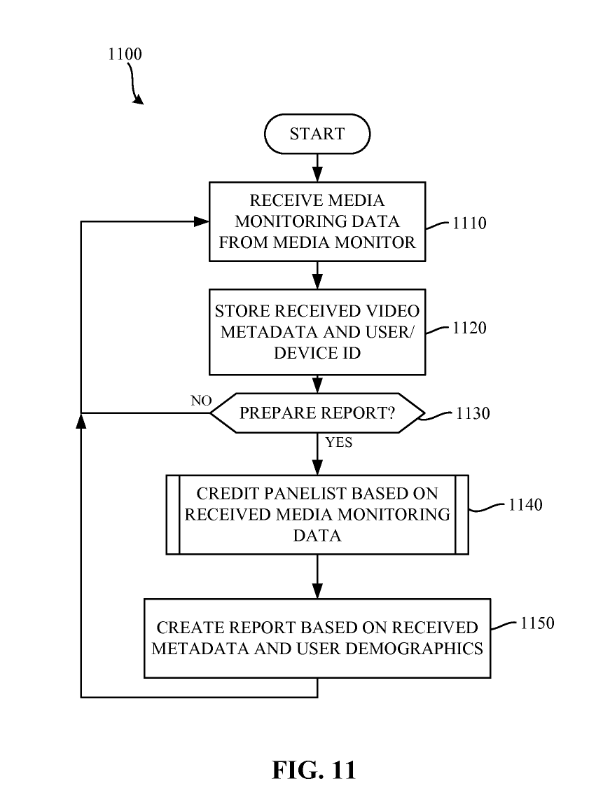

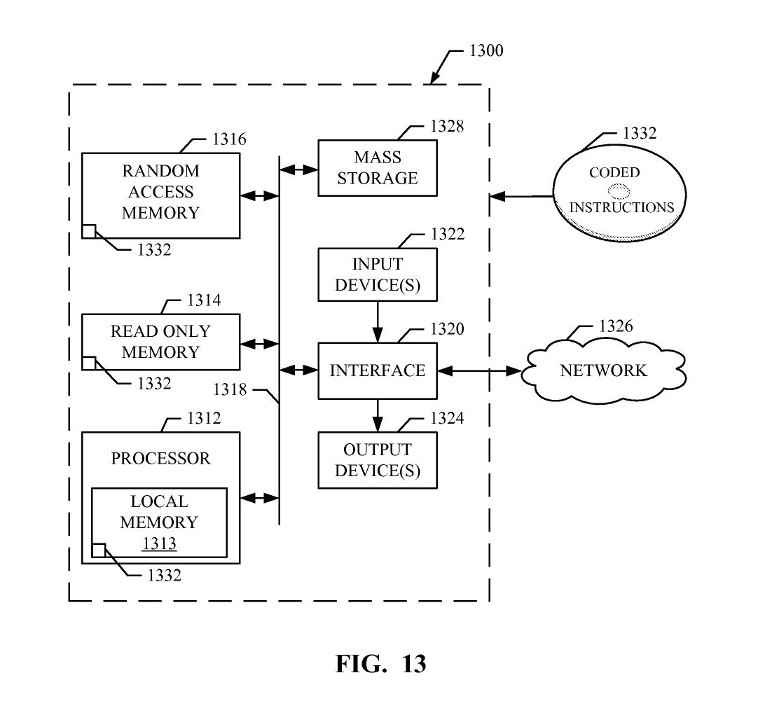

Flowcharts representative of example machine-readable instructions for implementing the example media monitor 110 of FIGS. 1 and/or 6 are shown in FIGS. 8 and/or 10. Flowcharts representative of example machine-readable instructions for implementing the example central facility 170 of FIGS. 1 and/or 7 are shown in FIGS. 11 and/or 12. In these examples, the machine readable instructions comprise a program(s) for execution by a processor such as the processor 1312 shown in the example processor platform 1300 discussed below in connection with FIG. 13. The program may be embodied in software stored on a tangible computer readable storage medium such as a CD-ROM, a floppy disk, a hard drive, a digital versatile disk (DVD), a Blu-ray disk, or a memory associated with the processor 1312, but the entire program and/or parts thereof could alternatively be executed by a device other than the processor 1312 and/or embodied in firmware or dedicated hardware. Further, although the example program is described with reference to the flowcharts illustrated in FIGS. 8, 10, 11, and/or 12, many other methods of implementing the example media monitor 110 and/or the example central facility 170 may alternatively be used. For example, the order of execution of the blocks may be changed, and/or some of the blocks described may be changed, eliminated, or combined.

As mentioned above, the example processes of FIGS. 8, 10, 11, and/or 12 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and transmission media. As used herein, “tangible computer readable storage medium” and “tangible machine readable storage medium” are used interchangeably. Additionally or alternatively, the example processes of FIGS. 8, 10, 11, and/or 12 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and transmission media. As used herein, when the phrase “at least” is used as the transition term in a preamble of a claim, it is open-ended in the same manner as the term “comprising” is open ended.

FIG. 8 is a flowchart representative of example machine-readable instructions which may be executed to implement the media monitor 110 of FIGS. 1 and/or 6. The example program 800 the illustrated example of FIG. 8 begins at block 810 when the media identifier 610 determines whether media is being presented (block 810). In the illustrated example, the media identifier 610 determines that media is being presented by monitoring for codes and/or signatures within audio of the presented media. If, for example, no codes and/or signatures are detected, it can be assumed that no media is being presented. However, the determination of whether media is being presented may be made in any other fashion. For example, on/off detection may be used to determine whether a media device is on and/or presenting media, bandwidth to a streaming media device may be monitored, etc. If media is not being presented, the media identifier continues to determine whether media is being presented. (block 810). In some examples, the media identifier 610 waits a threshold amount of time before performing the determination of whether media is being presented again. If media is being presented block 810, the media identifier 610 determines whether the presented media is identifiable using codes and/or signatures. (block 820). If the media is identifiable using codes and/or signatures, the media identifier 610 records the media identification using the codes and/or signatures identification in the data store 640. (block 830). While in the illustrated example media is identified by the media identifier using traditional monitoring techniques such as codes and/or signatures, any other past, present, and/or future technique for identifying presented media may additionally or alternatively be used.

Once the media identifier 610 records the media identification and/or determines that the presented media is not identifiable (block 820), the communications processor 620 monitors network communications to determine whether the presented media is being streamed (block 840). In some examples, media may be presented but not be identifiable by the media identifier 610. In such an example, a determination that the media is being streamed and can be identified based on the streaming data enables identification of the presented media. In the illustrated example, the communications processor 620 identifies that media is being streamed by inspecting requests and/or replies transmitted on the local area network (LAN) to and/or from the media devices. If it is determined that media is being streamed (block 840), the communications processor 620 determines whether the media can be identified based on the streaming data (block 850). If the streamed media can be identified (block 850), the communications processor 620 records an identification of the streaming media in the data store 640 (block 860). In the illustrated example, the communications processor 620 identifies the media by inspecting a universal resource locator (URL) of the network communications. However, any other past, present, or future technique for inspecting network communications and/or identifying streaming media may additionally or alternatively be used.

The streaming device identifier 630 identifies the media device used to stream the media (block 870). In the illustrated example, the streaming device identifier 630 identifies the media device by inspecting network communications transmitted to and/or from the media device associated with the streaming media. In some examples, the streaming device identifier 630 resolves a hardware address of the media device associated with the streaming media. For example, the streaming device identifier 630 may perform an Address Resolution Protocol (ARP) lookup to determine a hardware address of a media device. In some examples, the hardware address is a media access control (MAC) address and enables identification of a make and/or model of the media device. In some examples, the streaming device identifier 630 inspects network communications transmitted by the media devices to identify properties of the network communications (e.g., particular fields in a packet header, a particular format of a message, etc.). For example, a steaming media device may transmit a device ID to an Internet media provider (e.g., the Internet media provider 130) when requesting media that may enable the Internet media provider to format the response for the particular requesting device. Extracting the device ID enables the streaming device identifier 630 to identify the streaming device. The streaming device identifier 630 records the identity of the streaming device in the data store 640.

The timestamper 670 then records a timestamp in the data store 640 (block 880). Timestamping enables accurate identification of when media was presented. Control proceeds to block 810, where the media identifier 610 continues to determine whether media is being presented (block 810).

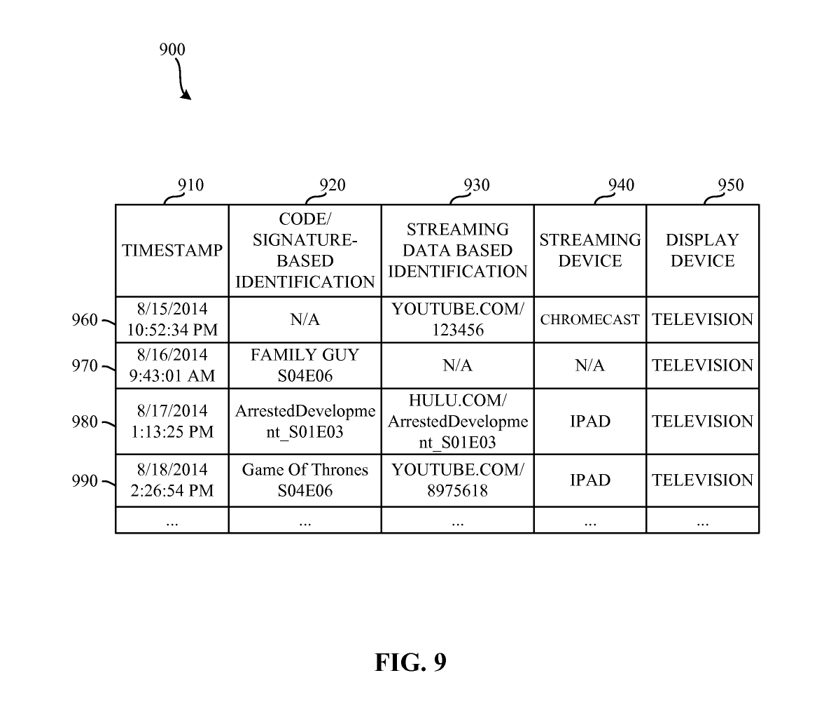

FIG. 9 is an example data table 900 representing example data collected by the example media monitor 110 of FIG. 1. The example data table 900 is stored in the data store 640, and is transmitted to the central facility 170 by the transmitter 660. The example data table 900 of the illustrated example of FIG. 9 includes a timestamp column 910, a code and/or signature based identification column 920, a streaming data based identification column 930, a streaming device identification column 940, and a display device column 950. The example data table 900 of the illustrated example of FIG. 9 includes a first example row 960, a second example row 970, a third example row 980, and a fourth example row 990.

The example timestamp column 910 indicates a time at which a media presentation was identified. In the illustrated example, the timestamp column 910 includes a date and time. However, any other timestamp format may additionally or alternatively be used. For example, the timestamp column may include a time zone identifier, the time may be formatted using a twenty four hour representation rather than the twelve hour representation of the illustrated example of FIG. 9, etc.

The example code and/or signature based identification column 920 indicates an identification of media that was detected using traditional monitoring techniques such as codes and/or signatures. In the illustrated example, the code and/or signature based identification column 920 includes a textual representation of the identified media. However, the identification may be stored in any other format. For example, the identification may be stored in a binary format. In some examples, the detected code and/or signature may be stored, as opposed to a textual representation of the identified media as shown in the example of FIG. 9.

The example streaming data based identification column 930 indicates an identification of media that was detected using streaming data based identification techniques, such as monitoring network communications. In the illustrated example of FIG. 9, the streaming data based identification column 930 includes a textual representation of a portion of a universal resource locator (URL) identified in association with the monitored network communications. However, the identified media may be identified in any other fashion. In the illustrated example of FIG. 9, the example streaming data based identification column 930 includes a domain name identifying the Internet media provider 130 that provided the media to the streaming device. Identifying the Internet media provider enables correlation of demographic data with the use of a particular Internet media provider (e.g., younger users use HULU to view media more often than Netflix).

The example streaming device column 940 indicates an identification of a streaming device associated with the streaming media. In the illustrated example, the streaming device column 940 includes text data representing a name of the streaming device. However, the streaming device column 940 may additionally and/or alternatively include any other data such as, for example, a hardware address of the streaming device, a version number of the streaming device, a brand of the streaming device, etc.

The example display device column 950 indicates an identification of the device used to present the media. In some examples, the media monitor 110 may monitor multiple media devices within a household. As such, the media monitor may, in some examples, record an identification of the media device that was used to present the identified media. In the illustrated example, the display device column 950 includes text data representing a name and/or other identifier used to identify the media device used to present the identified media. However, the example display device column 950 may additionally and/or alternatively include any other data such as, for example, a brand of the media device used to present the identified media, etc. Correlation of the streaming device column 940 and the display device column 950 enables the monitoring entity to identify trends and/or usage patterns among different types of devices. For example, users who own a VIZIO brand television may be more likely to stream media from an iPad device than other types of streaming devices.

The first example row 960 of FIG. 9 identifies that a YOUTUBE video was streamed to the television from a ChromeCast. The YOUTUBE video of the illustrated example was not identified by the use of codes and/or signatures. In such an example, monitoring network communications to identify the streaming media enables identification of a media presentation that might not have otherwise been identified.

The second example row 970 of FIG. 9 identifies that “Family Guy” was presented via the television, and that no streaming-based identification or streaming device was detected. As such, it can be assumed that the media identified in the second example row 970 was not streamed.

The third example row 980 of FIG. 9 identifies that “Arrested Development” was displayed by the television. Concurrently, the same episode of “Arrested Development” was streamed to the iPad. Because of the match between the presented media and the streamed media, it can be assumed that the iPad was used to stream the media for display via the television.

The fourth example row 990 of FIG. 9 identifies that “Game of Thrones” was displayed by the television. At the same time, a video was streamed from YOUTUBE to the iPad. While media was presented via the television and streamed at approximately the same time, the example media identified in the code and/or signature based identification column 920 of row 990 does not match the example media identified in the streaming data based identification column 930 of row 990. Accordingly, it can be assumed that the media presented by the television was not streamed from the iPad.

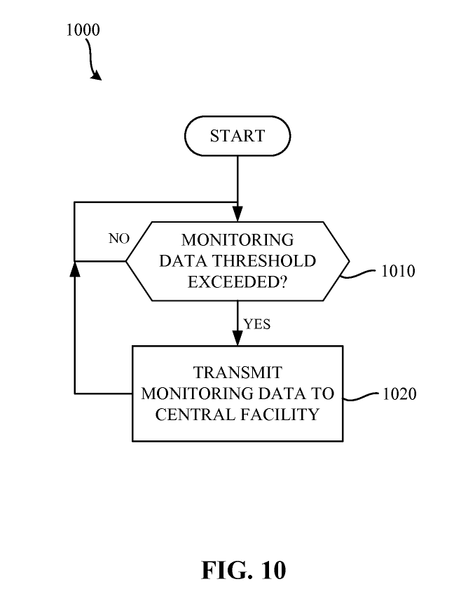

FIG. 10 is a flowchart representative of example machine-readable instructions which may be executed to implement the media monitor 110 of FIGS. 1 and/or 6 to transmit stored monitoring information. The example program 1000 of FIG. 10 begins at block 1010 when the transmitter 660 determines whether a data storage threshold has been exceeded (block 1010). In the illustrated example, the threshold is a time limit specifying that monitoring data is transmitted once every day. Additionally or alternatively, any other periodic and/or aperiodic approach to transmitting monitoring information from the media monitor 110 may be used. For example, the data threshold might be based on an amount of monitoring information stored in the data store 420.

If the threshold has not been exceeded (block 1010) the transmitter 660 continues to determine whether the monitoring information exceeds the threshold. When the monitoring information threshold has been exceeded (block 1010), the transmitter 660 transmits the stored monitoring information to the central facility 170. In the illustrated example, the transmitter 660 transmits the stored monitoring information via the network 125. However, in some examples, the transmitter 660 transmits the stored network communications via a local connection such as, for example, a serial connection, a universal serial bus (USB) connection, a Bluetooth connection, etc. When the transmitter 660 transmits via the local connection, the network media monitor 110 may be physically moved to a location of the central facility 170 by, for example, physically mailing the media monitor 110, etc.

FIG. 11 is a flowchart representative of example machine-readable instructions which may be executed to implement the example central facility 170 of FIGS. 1 and/or 7. The example program 1100 of the illustrated example of FIG. 11 begins at block 1110 when the Internet interface 171 receives media monitoring information from a media monitor 110 (block 1110). In the illustrated example, the media monitoring information includes a user and/or device identifier to identify a panelist and/or panelist device associated with a media presentation. The user and/or device identifier enables correlation of the media monitoring events with a particular panelist and/or panelist demographic.

The example media monitoring processor 720 stores the received media monitoring information (block 1120). In the illustrated example, the received media monitoring information and user/device identifier stored in the media monitoring database 730. However, the monitoring information and user/device identifier may be stored in any other location.

The example media monitoring processor 720 determines if a report should be prepared (block 1130). In the illustrated example, the report is prepared based on a request received from a third party (e.g., an advertiser, a media publisher, etc.). However, the report may be prepared upon satisfaction of any other condition such as, for example, a threshold time having elapsed (e.g., prepare a report once a month), a threshold volume of media monitoring information having been received (e.g., only prepare a report once one thousand media viewing occurrences have been received), etc.) If a report is not to be prepared (block 1130), the Internet interface 171 continues to receive monitoring information and user/device identifier(s) from the media monitor 110 (block 1110).

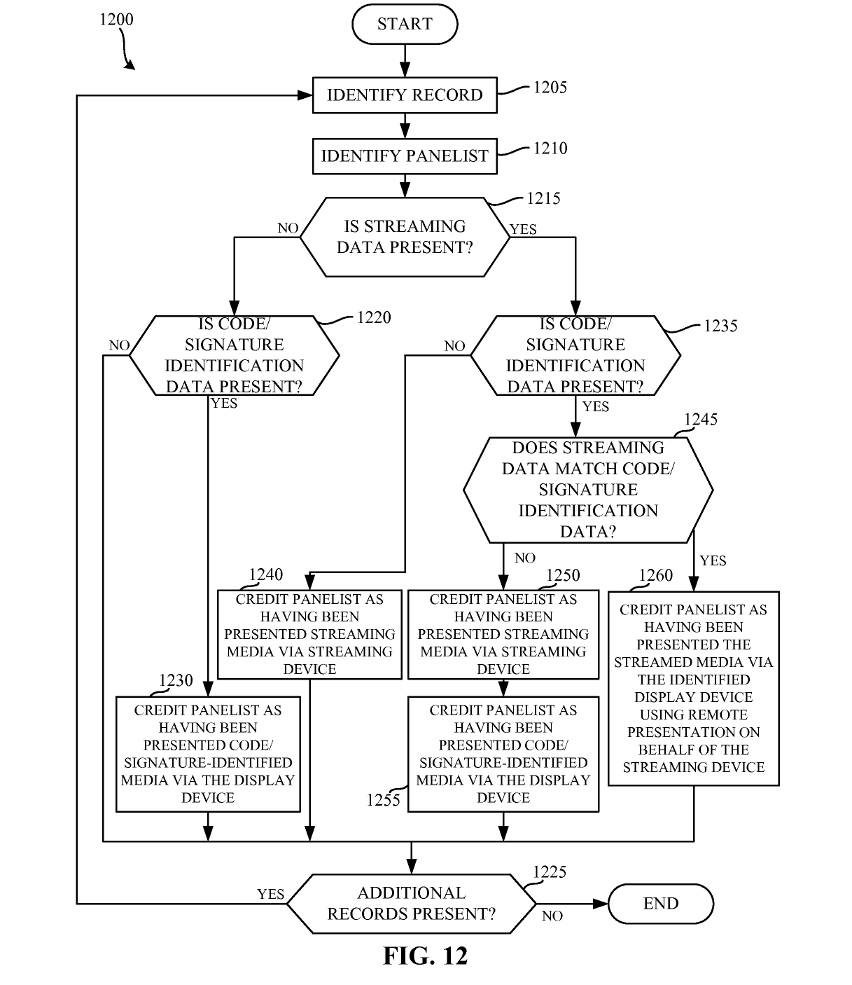

If a report is to be prepared (block 1130), the example media monitoring processor 720 processes the media monitoring data to credit the panelist (block 1140). In the illustrated example, the media monitoring processor 720 interfaces with the user identifier determiner 710 to identify demographic information in association with the received user/device identifier(s). In some examples, the received user/device identifier identifies a device that monitored the media presentation. In some examples, the device may not be associated with a single user, but instead, may be associated with multiple users and/or a particular location. For example, the location may be a household where a media monitor has been installed. In such an example, demographics of persons at the media monitoring location may be imputed to identify a general demographic of persons to which the media was presented, as well as how the media was presented (e.g., presented using remote presentation techniques). For example, media may have been identified at a household comprising a Caucasian family. As such, demographic information of the Caucasian family may be applied to the identified media. An example process for crediting a panelist based on the received media monitoring information is described in connection with FIG. 12. The example reporter 740 then creates a report based on the received monitoring information and the user demographics (block 1150). The report may be used to, for example, determine usage statistics of streaming devices within households of various demographics, etc.

FIG. 12 is a flowchart representative of example machine-readable instructions which may be executed to implement the example central facility 170 of FIGS. 1 and/or 7. The example program 1200 of the illustrated example of FIG. 12 begins at block 1205 when the media measurement processor 720 identifies a record stored in the media monitoring database 730. (block 1205). As described in connection with FIG. 9, the example first row 960, the example second row 970, the example third row 980, and/or the example fourth row 990 represent example records. Once a record to be processed is identified, the example user ID determiner 710 identifies a panelist and/or group of panelists (e.g., a household) associated with the identified record. (block 1210). Identifying the panelist and/or group of panelists enables correlation of the record of media presentation with a demographic of the panelist and/or group of panelists.

The example media monitoring processor 720 determines whether streaming data is present in association with the record. (block 1215). In the illustrated example, the example media monitoring processor 720 identifies whether streaming data is present by inspecting the streaming data based identification column (e.g., column 930 of FIG. 9). If no streaming data is present, the example media monitoring processor 720 determines whether codes and/or signatures based identification data is present. (block 1220). The example media monitoring processor 720 determines whether codes and/or signatures based identification data is present by inspecting the codes and/or signatures based identification column (e.g., column 920 of FIG. 9). If no codes and/or signatures are present, no crediting occurs. Control proceeds to block 1225 where the example media monitoring processor 720 determines whether additional records for crediting are present. (block 1225). If codes and/or signatures based identification data is present (block 1220), the example media monitoring processor 720 credits the identified panelist as having been presented the identified media via the display device. (block 1230). In the illustrated example, the display device is identified based on the received metering data (e.g., the display device column 950 of FIG. 9).

Returning to block 1215, if streaming data is present in the identified record (block 1215), the example media monitoring processor 720 determines whether codes and/or signatures based identification data is present in the identified record (block 1235). The example media monitoring processor 720 determines whether codes and/or signatures based identification data is present by inspecting the codes and/or signatures based identification column (e.g., column 920 of FIG. 9). If no codes and/or signatures are present, the example media monitoring processor 720 credits the panelist as having been presented the streaming media via the streaming device. (block 1240). In the illustrated example, the streaming device is identified based on the received metering data (e.g., the streaming device column 940 of FIG. 9). Identifying that streaming media was presented by a streaming device (e.g., an iPad) enables accurate crediting of media presented by streaming devices.

If, in addition to streaming data being present (block 1215), codes and/or signatures based identification data is also present (block 1235), the example media monitoring processor 720 determines whether the streaming data matches the codes and/or signatures based identification data (block 1245). In the illustrated example, the example media monitoring processor 720 determines whether the streaming data matches the codes and/or signatures based identification data by determining whether the same media is identified (e.g., a same television show, a same song, etc.) For example, referring to FIG. 9, the third example row 980 identifies the television show “Arrested Development” in both the streaming data based identification (e.g., column 930), as well as the codes and/or signatures based identification (e.g., column 920). In contrast, the fourth example row 990 identifies the television show “Game of Thrones” via the codes and/or signatures based identification (e.g., column 920), while a different YOUTUBE video was identified in the streaming data (e.g., column 930). In some examples, matches are identified by retrieving a sample of the media (e.g., by requesting the streaming media from the URL identified in the streaming data) and determining a similarity between the streaming media and the codes and/or signatures based identified media. In such an example, when the similarity is above a threshold, the streaming data and the audio-based identification data are considered a match. Identifying such a match between the streaming data and the codes and/or signatures based identification data enables identification of whether remote presentation was used to present the streaming media. For example, the third example row 980 of FIG. 9 indicates that the television show “Arrested Development” was streamed to an iPad (e.g., the streaming device identified in column 940), but was remotely presented via the television (e.g., the display device identified in column 950).

If the example media monitoring processor 720 determines that the streaming data does not match the codes and/or signatures based identification data (i.e., the streaming data identifies media different from the codes and/or signatures based identification data), the example media monitoring processor 720 credits the panelist as having been presented streaming media (i.e., the media identified by the streaming data) via the streaming device. (block 1250). The example media monitoring processor 720 then credits the panelist as having been presented the media identified by the codes and/or signatures based identification data) via the display device. (block 1255). The example media monitoring processor 720 then determines if additional records are present for crediting analysis. (block 1225).

If the example media monitoring processor 720 determines that the streaming data matches the codes and/or signatures based identification data (i.e., the streaming data identifies the same media as the codes and/or signatures based identification data), the example media monitoring processor 720 credits the panelist as having been presented the streaming media via the display device using remote presentation on behalf of the streaming device. (block 1260). For example, the third example row 980 of the illustrated example of FIG. 9 indicates that the same media (i.e., the television show “Arrested Development”) was presented via a television on behalf of an iPad. Crediting in such a fashion enables monitoring companies to identify when streaming media devices are involved in media presentations. Understanding such involvement is beneficial because it enables identification of trends in streaming media presentations such as, for example, users are more likely to use a television with integrated streaming functionality than using a television and a separate streaming media device. Once crediting is complete, the example media monitoring processor 720 then determines if additional records are present for crediting analysis (block 1225), and, if so, proceeds to process the additional records (block 1205).

FIG. 13 is a block diagram of an example processor platform 1300 capable of executing the instructions of FIGS. 8, 10, 11, and/or 12 to implement the example media monitor 110 of FIGS. 1 and/or 6, and/or the example central facility 170 of FIGS. 1 and/or 7. The processor platform 1300 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 1300 of the illustrated example includes a processor 1312. The processor 1312 of the illustrated example is hardware. For example, the processor 1312 can be implemented by one or more integrated circuits, logic circuits, microprocessors or controllers from any desired family or manufacturer.

The processor 1312 of the illustrated example includes a local memory 1313 (e.g., a cache). The processor 1312 of the illustrated example is in communication with a main memory including a volatile memory 1314 and a non-volatile memory 1316 via a bus 1318. The volatile memory 1314 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1316 may be implemented by flash memory and/or any other desired type of memory device. Access to the main memory 1314, 1316 is controlled by a memory controller.

The processor platform 1300 of the illustrated example also includes an interface circuit 1320. The interface circuit 1320 may be implemented by any type of interface standard, such as an Ethernet interface, a universal serial bus (USB), and/or a PCI express interface.

In the illustrated example, one or more input devices 1322 are connected to the interface circuit 1320. The input device(s) 1322 permit(s) a user to enter data and commands into the processor 1312. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1324 are also connected to the interface circuit 1320 of the illustrated example. The output devices 1024 can be implemented, for example, by display devices (e.g., a light emitting diode (LED), an organic light emitting diode (OLED), a liquid crystal display, a cathode ray tube display (CRT), a touchscreen), a tactile output device, and/or speakers. The interface circuit 1320 of the illustrated example, thus, typically includes a graphics driver card, a graphics driver chip or a graphics driver processor.

The interface circuit 1320 of the illustrated example also includes a communication device such as a transmitter, a receiver, a transceiver, a modem and/or network interface card to facilitate exchange of data with external machines (e.g., computing devices of any kind) via a network 1326 (e.g., an Ethernet connection, a digital subscriber line (DSL), a telephone line, coaxial cable, a cellular telephone system, etc.).

The processor platform 1300 of the illustrated example also includes one or more mass storage devices 1328 for storing software and/or data. Examples of such mass storage devices 1328 include floppy disk drives, hard drive disks, compact disk drives, Blu-ray disk drives, RAID systems, and digital versatile disk (DVD) drives.

The coded instructions 1332 of FIGS. 8, 10, 11, and/or 12 may be stored in the mass storage device 1328, in the volatile memory 1314, in the non-volatile memory 1316, and/or on a removable tangible computer readable storage medium such as a CD or DVD.

From the foregoing, it will be appreciated that the above disclosed methods, apparatus, and articles of manufacture enable identification of remote presentation of streaming media.

As disclosed herein, example methods, apparatus, and articles of manufacture may be used to credit a panelist based on both streaming data and audio identification data. Crediting a panelist using both streaming data and audio identification data enables more accurate identification of presented media. Moreover, such crediting reduces memory requirements for crediting data. For example, whereas a panelist would be credited separately when being credited for exposure to streaming media based on the streaming data and the audio identification data (e.g., using two separate records, one for each type of data), in examples disclosed herein, a single crediting record may be used. Using fewer records results in lower memory requirements for such a crediting system. Moreover, when the stored records are later processed to generate a report (e.g., to create a media exposure report), there are fewer records to process, resulting in a decrease of processing power required to generate the report.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. A method to identify remote presentation of streaming media, the method comprising:
determining a first identification of streaming data transmitted to a streaming media device;
determining a second identification of media presented by a media presentation device;
comparing, with a processor, the first identification to the second identification to determine whether first media identified by the first identification matches second media identified by the second identification; and
in response to determining that the first media matches the second media, crediting, with the processor, a panelist associated with at least one of the streaming media device and the media presentation device as having been presented the first media by the media presentation device on behalf of the streaming media device.

2. The method as described in claim 1, further comprising, in response to determining that the first media does not match the second media, crediting the panelist as having been presented the first media by the streaming media device.

3. The method as described in claim 1, further comprising, in response to determining that the first media does not match the second media, crediting the panelist as having been presented the second media by the media presentation device.

4. The method as described in claim 1, further comprising receiving a media monitoring record, the media monitoring record including the first identification, the second identification, and a panelist identifier.

5. The method as described in claim 1, further comprising creating a report indicating media exposure based on the crediting.

6. The method as described in claim 1, wherein determining the first identification of streaming data transmitted to the streaming media device comprises monitoring network communications to identify streaming media.

7. The method as described in claim 6, wherein monitoring the network communications to identify the streaming media further comprises inspecting the network communications to identify a Universal Resource Locator identifying the streaming media.

8. The method as described in claim 1, wherein determining the second identification of media presented by the media presentation device comprises detecting at least one of a code and a signature emitted from the media presentation device.

9. A tangible machine-readable storage disk or storage device comprising instructions which, when executed, cause a machine to at least:
determine a first identification of streaming data transmitted to a streaming media device;
determine a second identification of media presented by a media presentation device;
determine whether first media identified by the first identification matches second media identified by the second identification; and
in response to determining that the first media matches the second media, credit a panelist associated with at least one of the streaming media device and the media presentation device as having been presented the first media by the media presentation device on behalf of the streaming media device.

10. The machine-readable storage disk or storage device as described in claim 9, further comprising instructions which, when executed, cause the machine to, in response to determining that the first media does not match the second media, credit the panelist as having been presented the first media by the streaming media device.

11. The machine-readable storage disk or storage device as described in claim 9, further comprising instructions which, when executed, cause the machine to, in response to determining that the first media does not match the second media, credit the panelist as having been presented the second media by the media presentation device.

12. The machine-readable storage disk or storage device as described in claim 9, further comprising instructions which, when executed, cause the machine to receive a media monitoring record, the media monitoring record including the first identification, the second identification, and a panelist identifier.

13. The machine-readable storage disk or storage device as described in claim 9, further comprising instructions which, when executed, cause the machine to create a report indicating media exposure based on the crediting.

14. The machine-readable storage disk or storage device as described in claim 9, wherein determining the first identification of streaming data transmitted to the streaming media device comprises monitoring network communications to identify streaming media.

15. The machine-readable storage disk or storage device as described in claim 9, wherein monitoring the network communications to identify the streaming media further comprises inspecting the network communications to identify a Universal Resource Locator identifying the streaming media.

16. The machine-readable storage disk or storage device as described in claim 9, wherein determining the second identification of media presented by the media presentation device comprises detecting at least one of a code and a signature emitted from the media presentation device.

17-20. (canceled)
